(19) United States
(12) Patent Application Publication
(10) Pub. No.: US 2002/0029482 A1
(43) Pub. Date: Mar. 14, 2002

(54) Knife with automatically retractable blade

(76) Inventors: Jean-Claude Peyrot, Bordeaux (FR); Marc Michiels, Salies De Bearn (FR)

Correspondence Address: YOUNG & THOMPSON, 745 SOUTH 23RD STREET 2ND FLOOR, ARLINGTON, VA, 22202

(21) Appl. No.: 09/891,260

(22) Filed: Jun. 27, 2001

(30) Foreign Application Priority Data
Jun. 27, 2000 (FR) 00 08232

(51) Int. Cl. B26B 1/08

(52) U.S. Cl. 30/162; 30/335

(57) ABSTRACT

The object of the invention is a knife comprising a casing (2) and a blade (6) which can have two positions, a first so-called extended position, in which the blade (6) projects outside the casing (2), and a second so-called retracted position, in which the blade (6) is disposed integrally within the casing (2), characterized in that it comprises a blade carrier (4) to which is connected the blade (6), a housing (3) on which is slidably mounted said blade carrier (4) removably mounted within the casing (2) and a finger piece-pusher (7) mounted slidably on the casing so as to move forwardly said blade carrier (4) so as to place the blade in cutting position, said blade carrier (4) and finger piece-pusher (7) being returned to the retracted rest position by return springs (8-11), and in that means (7b, 16, 17) are provided to secure the finger piece-pusher (7) and the blade carrier (4) together to place the blade in said first position, said means being uncoupled by a conjoint action of rotation and extraction of the blade carrier (4) relative to the finger piece-pusher (7), resulting from the cutting action.

The present invention has for its object a knife provided with a blade which can automatically retract as soon as said blade is no longer in contact with the object to be cut.

A knife generally comprises a casing in which a blade can slide, fixed to a blade carrier, which can have two positions, a first so-called extended position, in which the blade projects outside the casing, and a second so-called retracted position, in which the blade is disposed integrally within the casing.

In a simple modification, the blade carrier moves in a slideway provided in the casing, and comprises notches which permit holding said blade carrier, and hence the blade, in a predetermined position.

This modification is not satisfactory from a standpoint of safety, because the blade remains in the extended position, risking causing harm, if the user does not think to retract it after use.

A first improvement consists in providing at the level of the blade carrier return means to the retracted position. In this case, the blade carrier comprises a finger piece adapted to be moved by the thumb of the user so as to cause the blade to extend or to hold the blade in extended position. Thus, as soon as the user releases the finger piece, the return means automatically return the blade to the retracted position.

Even if this improved version provides greater safety than the simple version, it remains no less dangerous at the time of the end of cutting, the instant when the greatest number of accidents occur.

Thus, to cut an object with a knife, the user must exert a relatively great force in the direction of the object to be cut, and give a cutting movement to the knife directed toward himself. Also, at the end of cutting, at the time at which the knife ceases to be in contact with the object, control of the knife can escape the user, so that the knife, and more particularly the blade, can come into contact with a portion of the body of the user and cut him, unless he has had the reflex to release the finger piece so that the blade retracts.

Also, the present invention seeks to overcome the drawbacks of knives of the prior art by providing a reliable and secure knife, provided with a blade which retracts automatically as soon as said blade is no longer in contact with the object to be cut.

To this end, the invention has for its object a knife comprising a casing and a blade which can have two positions, a first so-called extended position, in which the blade projects outside the casing, and a second so-called retracted position, in which the blade is disposed integrally within the casing, characterized in that it comprises a blade carrier to which is connected the blade, a housing on which is slidably mounted said blade carrier removably mounted within the casing, and a finger piece-pusher mounted slidably on the casing so as to move said blade carrier forwardly thereby to place the blade in the cutting position, said blade carrier and finger piece-pusher being returned to the retracted or rest position, by return springs, and in that means are provided to secure the finger piece-pusher and the blade carrier together to place the blade in said first position, said means being uncoupled by the conjoint action of rotation and extraction of the blade carrier relative to the finger piece-pusher, following the cutting action.

According to one embodiment, said disconnectable means are constituted by a drive finger secured to said finger piece-pusher, whose end is provided with a notch for receiving a projection secured to the blade carrier, said notch and projection being laterally offset in the rest or retracted position of the finger piece and the blade carrier, placed in alignment and in engagement upon the beginning of movement of the finger piece-pusher and uncoupled as soon as the blade is in the course of cutting, such that said notch will no longer be on the return path of the projection during retraction of the blade carrier.

There is thus obtained a knife with a truly safe retractable blade in the sense that the blade is already placed in automatic retraction position, as soon as traction is exerted on the knife to carry out a cut, the retraction taking place automatically as soon as the blade leaves or escapes from the object or element which has been cut, without having to exert any action on the finger piece-pusher.

Other characteristics and advantages will become apparent from the description which follows, of an embodiment of a cutter according to the invention, which description is given by way of example only and with respect to the accompanying drawings, in which:

FIG. 1 is a side elevational view of a knife according to the invention;

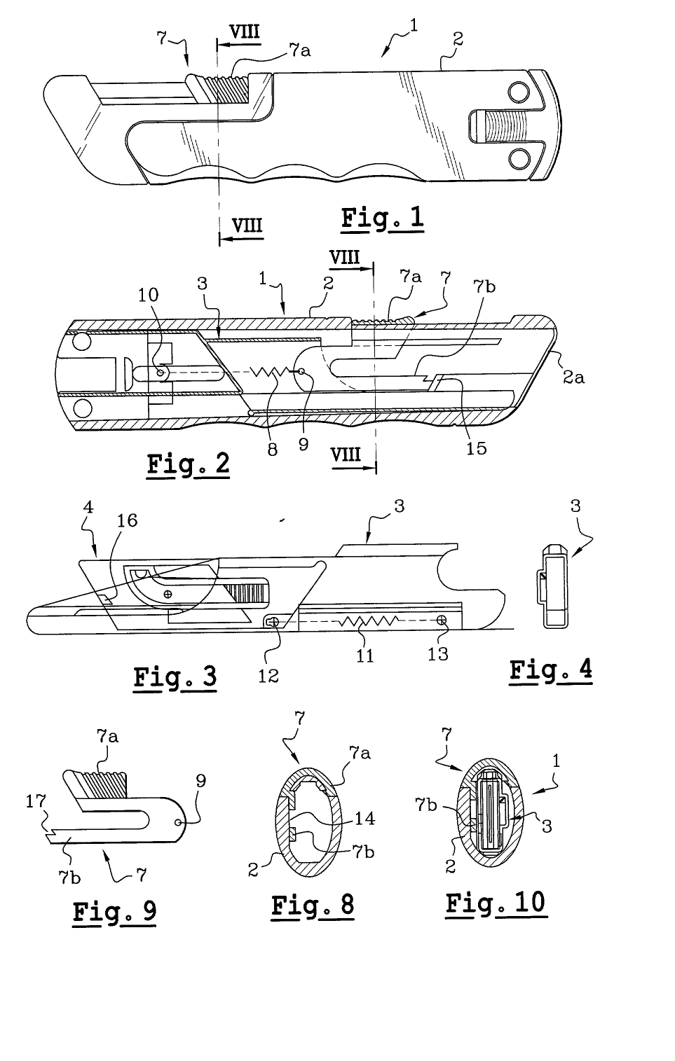

FIG. 2 is a cross-sectional view on a median plane containing the longitudinal axis of the knife of FIG. 1;

FIG. 3 is a side elevational view of the housing with the blade carrier of the knife;

FIG. 4 is a left side view of the housing of FIG. 3;

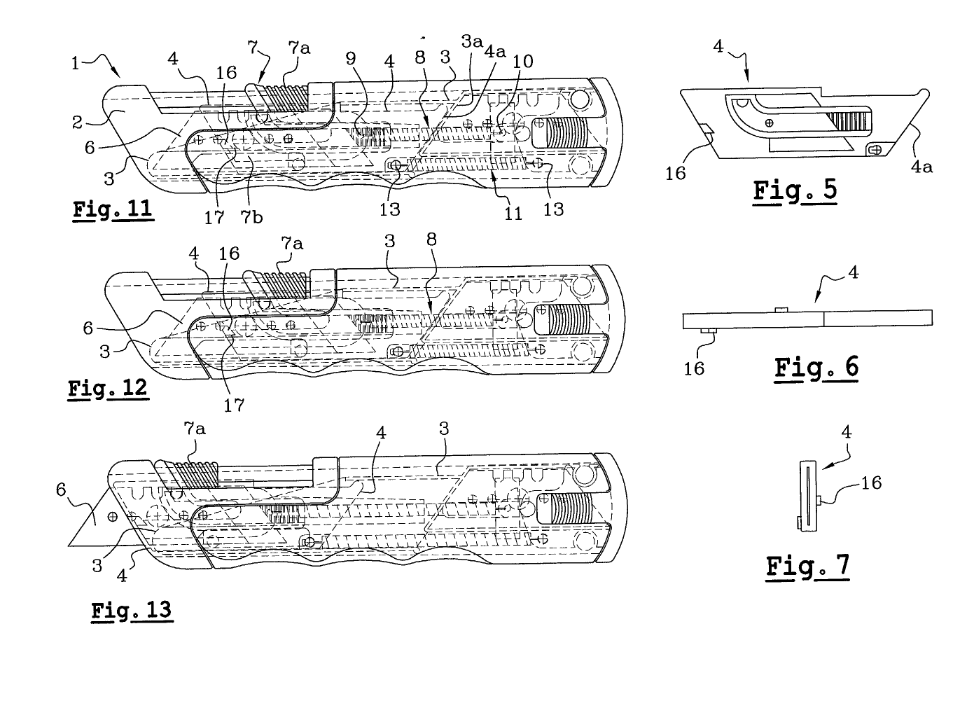

FIG. 5 is a side elevational view of the blade carrier of FIG. 3;

FIG. 6 is a top plan view of the blade carrier;

FIG. 7 is a view from the left of the blade carrier;

FIG. 8 is a cross-sectional view on the line VIII-VIII of FIGS. 1 and 2 without the assembly of housing and blade carrier;

FIG. 9 is a side elevational view of the finger piece-pusher;

FIG. 10 is a cross-sectional view on the line VIII-VIII of FIG. 1 with the assembly of the housing and blade carrier, and

FIGS. 11 to 16 show different positions of the movable elements of the knife in the course of use.

In the drawings, there is shown at numeral 1 a knife comprising a casing 2 forming a sleeve of generally substantially elliptical cross-section, within which is disposed a housing 3 carrying, on the one hand, a blade carrier 4 and, on the other hand, a blade 6 of conventionally trapezoidal shape.

The blade carrier 4 is slidably mounted in the housing 3 at the front of this latter at the distal portion of the casing 2 which is open at its end to provide a passage, through a rectangular slot, of the end of the blade 6 carried by the blade carrier 4, when the knife is in the cutting position (FIGS. 13, 14).

The blade carrier 4 is moved with the help of a finger piece-pusher 7 comprising (FIG. 9) a finger piece 7a slidably mounted on the casing 2 in its front half portion and a drive finger 7b directed forwardly of the knife and arranged (FIGS. 8 and 10) between one of the flanks of the assembly of the housing 3 and blade carrier 4 and the internal flank facing the casing 2.

The finger piece 7 is returned to its rest position (FIGS. 1, 2, 11) by a spring 8 anchored at 9 on the finger piece 7 and at 10 on the housing 3.

The blade carrier 4 is returned to its rest position shown in FIGS. 3 and 11 by a spring 11 anchored at 12 on the blade carrier 4 and at 13 on the housing 3.

The drive finger 7b slides along a flat internal surface 14 of the casing and encounters, practically as soon as the finger piece 7a leaves its rest position when it is pressed forwardly, a small inclined ramp 15 (FIG. 2) which deflects laterally the end of the finger 7b inwardly of the casing 2 in the direction of a projection 16 (FIGS. 5 and 7) provided laterally of the blade carrier 4.

More precisely, as shown particularly in FIGS. 5, 9, 11 and 12, the finger 7b is provided with a notch V17 of a shape corresponding to said projection 16.

At rest (FIG. 11), the end of the finger 7b is laterally offset relative to the projection 17 and slightly retracted relative to this latter.

As soon as the finger piece 7a begins to be moved forwardly (FIG. 12) the end of the finger 7b is deflected in the direction of the blade carrier 4 such that the notch 17 receives the projection 16. The blade carrier 4 is thus subjected to the finger 7b and is pressed forwardly of the knife 1 by the finger piece 7a which follows its path (FIG. 13) to the end. The pressure must be maintained on the finger piece 7a because the two return springs 8 and 11 are thus stressed. The nose of the blade carrier 4 is in abutment against a peripheral flange 2a (FIG. 2) of the casing 2 and the blade 6 projects at the end of the knife, ready for use.

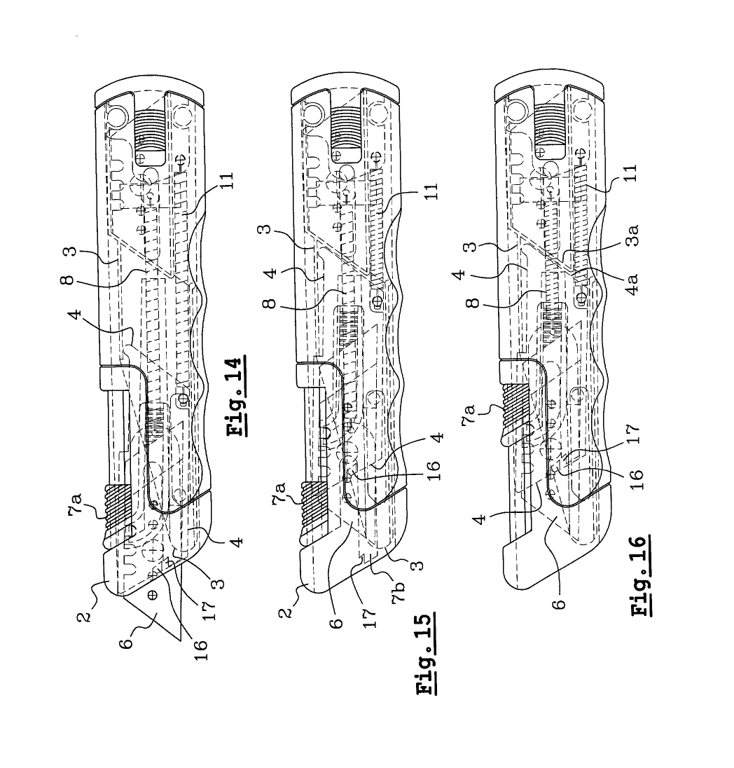

When the blade 6 is in action (FIG. 14), the traction exerted on the blade following the cutting action causes the blade carrier 4 to swing slightly within the casing 2 while the blade 6 projects slightly more, which has the effect of disengaging the projection 16 from the notch 17. Thus, as soon as the cutter is disengaged from the cut, the finger piece 7a being still in place at the end of its extension movement, the blade carrier 4, continuously urged backwardly by the spring 11, misses the notch 17 that would retain it and is automatically returned (FIG. 15) by said spring 11 to the rest position of FIG. 11.

Through retraction of the blade 6 completely within the casing 2 thus takes place automatically, without having to act on the finger piece 7a and, this happens as soon as traction on the blade 6 is no longer exerted to cut the element or object.

It is to be noted that when the cutter is in the position of FIG. 13 in which the blade 6 is extended, a simple pressure of this latter on the object or element to be cut will not disengage the projection 16 from the notch 17.

What is necessary is a cutting action applying a traction on the housing 2 whilst the blade 6 is retained pinched between the edges of the cut, to give rise to the conjoint action of slight swinging of the blade 6—blade carrier 4 assembly within the casing 2, the necessary play being provided for this purpose, and the slight supplemental withdrawal of said assembly outside the casing, this conjoint action giving rise to said disengagement and the positioning of the notch 17 outside the return path of the projection 16, which is to say of the blade carrier 4.

By releasing the finger piece 7a (FIG. 16) this latter is automatically returned by the spring 8 to the rest position of FIG. 11.

The blade carrier 4 is returned to the position at the same height of the projection 16 and the notch 17 by return swinging caused by the inclined wall 3a of the housing 3 which acts to straighten out the rear edge 4a of the blade carrier 4.

Finally, the invention is evidently not limited to the embodiment shown and described above but on the contrary covers all modifications, particularly as to the forward drive means of the blade carrier by the finger piece, these means being disengaged when the blade undergoes traction, which is to say during the cutting action.

1. Knife comprising a casing (2) and a blade (6) which can have two positions, a first so-called extended position, in which the blade (6) projects outside the casing (2), and a second so-called retracted position, in which the blade (6) is disposed integrally within the casing (2), characterized in that it comprises a blade carrier (4) to which is connected the blade (6), a housing (3) on which is slidably mounted said blade carrier (4) removably mounted within the casing (2) and a finger piece-pusher (7) slidably mounted on the casing so as to move forwardly said blade carrier (4) so as to place the blade in cutting position, said blade carrier (4) and finger piece-pusher (7) being returned to the retracted rest position with return springs (8-11), and in that means (7b, 16, 17) are provided to secure the finger piece-pusher (7) and the blade carrier (4) together to place the blade in said first position, said means being uncoupled by conjoint action of rotation and extraction of the blade carrier (4) relative to the finger piece-pusher (7) following the cutting action.

2. Knife according to claim 1, characterized in that said disconnectable means are constituted by a drive finger (7b) secured to said finger piece-pusher (7), whose end is provided with a notch (17) that receives a projection (16) secured to the blade carrier (4), said notch (17) and projection (16) being offset laterally in the rest or retracted position of the finger piece (7) and blade carrier (4), placed in alignment and in engagement at the beginning of the movement of the finger piece-pusher (7) and uncoupled as soon as the blade (6) is performing a cutting action, such that said notch (17) is no longer in the return path of the projection (16) during retraction of the blade carrier (4).

3. Knife according to claim 2, characterized in that said end of the drive finger (7b) is shifted laterally by a small ramp (15) provided on the internal wall of the casing (2).
